(19) United States
(12) Patent Application Publication
(10) Pub. No.: US 2025/0144576 A1
(43) Pub. Date: May 8, 2025

(54) METHOD FOR RECYCLING ION CONDUCTING MEMBRANES

(71) Applicant: Battelle Memorial Institute, Richland, WA (US)

(72) Inventors: Yuyan Shao, Richland, WA (US); Litao Yan, Richland, WA (US); Bingbin Wu, Richland, WA (US)

(73) Assignee: Battelle Memorial Institute, Richland, WA (US)

(21) Appl. No.: 18/934,959

(22) Filed: Nov. 1, 2024

Related U.S. Application Data
(60) Provisional application No. 63/595,495, filed on Nov. 2, 2023.

(51) Int. Cl. B01D 71/36; B01J 49/20; H01M 50/426

(52) U.S. Cl. CPC B01D 71/36; B01J 49/20; H01M 50/426

(57) ABSTRACT

Disclosed herein is a method for dissolving ion exchange membranes to provide dissolved polymers, particularly at low temperatures and/or pressures, that can be recast to regenerate ion exchange membranes exhibiting reduced defects compared to the initial ion exchange membrane. In some aspects of the disclosure, the polymer exchange membranes include a perfluorosulfonic acid polymer. In some aspects of the disclosure, the method involves dissolving the membranes in one or more aprotic solvents, particularly at temperatures below 80° C.

### CROSS REFERENCE TO RELATED APPLICATION

This application claims the benefit of and priority to the earlier filing date of U.S. Provisional Application No. 63/595,495, filed Nov. 2, 2023, which is incorporated by reference herein in its entirety.

### ACKNOWLEDGMENT OF GOVERNMENT SUPPORT

This invention was made with Government support under Contract DE-AC05-76RL01830 awarded by the U.S. Department of Energy. The Government has certain rights in the invention.

### FIELD

The present disclosure relates to methods for recycling ion conducting membranes, and recycled membranes obtained therefrom. Also disclosed are energy devices including ion conducting membranes and recycled ion conducting membranes according to the present disclosure.

### BACKGROUND

Ion conducting membranes have multiple useful applications in the energy sector. For example, these membranes are used in fuel cells and electrolyzers, where their combination of ionic conductivity and electrical resistance are particularly useful. Many ion conducting membrane materials, however, are expensive, and the properties of these membranes may degrade over the operational lifecycle of devices which use them. Additionally, the manufacturing and disposal of these materials involves energy-intensive and costly processes. Therefore, to reduce the costs associated with wear and use of ion conducting membranes in their various applications, cost-effective methods of recycling and regenerating these membranes are needed in the art.

### SUMMARY

Disclosed herein are methods of recycling ion exchange membrane materials, including such materials that have become contaminated or damaged during the lifecycle of the device. These methods may comprise exposing a contaminated or damaged ion exchange membrane to one or more solvents at specific temperatures and/or pressures to cause the membranes to dissolve. The dissolved membrane material may thereafter be recast to form a regenerated membrane. Also disclosed herein are recycled membranes obtained from the recycling methods disclosed herein. The recycled membranes can comprise an ion-permeable ionomer, such as a perfluorosulfonic acid polymer, with a comparatively reduced concentration of contaminants and defects relative to the concentration present in the material prior to recycling. In particular aspects of the disclosure, these perfluorosulfonic acid polymers have a hydrophobic stable fluorocarbon chain backbone and hydrophilic sulfonic acid groups attached to the fluorocarbon chain.

Also disclosed herein are devices including regenerated ion exchange membranes obtained from the recycling method disclosed herein. The devices including these polymers, in some aspects of the disclosure, include fuel cells, flow batteries, and electrolyzers. In such aspects of the disclosure, the ion exchange membranes serve to electrically isolate positive and negative electrodes, while permitting the transfer of ions between the positive electrode and the negative electrode.

Certain aspects concern a method for recycling an ion exchange membrane, comprising: exposing a first ion exchange membrane to a solvent at a first temperature and a first pressure; dissolving the first ion exchange membrane to form a polymer dispersion; and recasting the polymer dispersion to form a second ion exchange membrane from the polymer dispersion, the second ion exchange membrane being a recycled membrane. In some aspects of the disclosure, the first ion exchange membrane comprises a polymer, the first temperature is lower than 100° C., such as lower than 80° C., and the second ion exchange membrane comprises a lower concentration of oxygen radicals or a lower concentration of metal ions than the first ion exchange membrane.

Certain aspects of the disclosure concern a device including an ion exchange membrane recycled according to the method described herein.

Certain aspects of the disclosure concern an ion exchange device, comprising (i) a positive electrode, (ii) a negative electrode, (iii) a polymer membrane disposed between the positive electrode and the negative electrode, wherein the polymer membrane is permeable to ions and impermeable to electrons, and (iv) an electrical load in electrical communication with the positive electrode and the negative electrode. The polymer membrane comprises a material recycled by dissolving and recasting a perfluorosulfonic acid polymer in an aprotic solvent solution to form a polymer dispersion and recasting the polymer dispersion to form a regenerated membrane.

The foregoing and other objects, features, and advantages of the present disclosure will become more apparent from the following detailed description, which proceeds with reference to the accompanying figures.

### BRIEF DESCRIPTION OF THE DRAWINGS

FIG. 1A shows the chemical structure of Nafion®.

FIG. 1B shows the chemical structure of Aquivion®.

FIG. 2A shows the chemical structure of trimethyl phosphate.

FIG. 2B shows the chemical structure of tripropyl phosphate.

FIG. 2C shows the chemical structure of tributyl phosphate.

FIG. 2D shows the chemical structure of triethyl phosphate.

FIG. 3A shows the chemical structure of dimethyl methylphosphonate.

FIG. 3B shows the chemical structure of diethyl ethylphosphonate.

FIG. 4 shows the chemical structure of triethyl phosphite.

FIG. 5 shows the chemical structure of dimethyl sulfoxide.

FIG. 6A shows the chemical structure of N,N-dimethylformamide.

FIG. 6B shows the chemical structure of dimethylacetamide.

FIG. 7 is a schematic diagram of an exemplary aqueous flow battery according to one aspect of the present disclosure, the aqueous flow battery including an ion exchange membrane.

FIG. 8 is an exemplary aqueous flow battery according to another aspect of the present disclosure, wherein the battery comprises interleaved manifolds.

FIG. 9 is a schematic diagram of an exemplary fuel cell according to one aspect of the disclosure, the fuel cell including an ion exchange membrane.

FIG. 10 is a schematic diagram of an exemplary electrolyzer according to one aspect of the disclosure, the electrolyzer including an ion exchange membrane.

### DETAILED DESCRIPTION

### 1. Definitions

The following explanations of terms and abbreviations are provided to better describe the present disclosure and to guide those of ordinary skill in the art in the practice of the present disclosure. As used herein, “comprising” means “including” and the singular forms “a” or “an” or “the” include plural references unless the context clearly indicates otherwise. The term “or” refers to a single element of stated alternative elements or a combination of two or more elements unless the context clearly indicates otherwise.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the following detailed description and the claims.

Unless otherwise indicated, all numbers expressing quantities of components, percentages, temperatures, times, and so forth, as used in the specification or claims are to be understood as being modified by the term “about.” Accordingly, unless otherwise indicated, implicitly or explicitly, the numerical parameters set forth are approximations that may depend on the desired properties sought and/or limits of detection under standard test conditions/methods, as known to those persons of ordinary skill in the art. When directly and explicitly distinguishing embodiments from discussed prior art, the embodiment numbers are not approximates unless the word “about” is recited. Furthermore, not all alternatives recited herein are equivalents.

The features described herein with regard to any example can be combined with other features described in any one or more of the examples, unless otherwise stated.

To facilitate review of the various aspects of the disclosure, the following explanations of specific terms are provided:

Adjacent: When used in reference to the position of one or components of a device, this term refers to a physical orientation (or ordering) of the components of the device (e.g., the positive electrode, the negative electrode, and/or the ion exchange membrane of the device) and another component of the device wherein the reference component and the other component are physically associated, either directly or through one or more intervening.

Catalyst: A substance, usually present in small amounts relative to reactants, which increases the rate of a chemical reaction without itself being consumed or undergoing a chemical change. A catalyst also may enable a reaction to proceed under different conditions (e.g., at a lower temperature) than otherwise possible.

Electrolyte: A substance containing free ions and/or radicals that behaves as an ionically conductive medium. In a redox flow battery, some of the free ions and/or radicals are electrochemically active components. An electrolyte in contact with the anode, or negative half-cell, may be referred to as an anolyte, and an electrolyte in contact with the cathode, or positive half-cell, may be referred to as a catholyte. The anolyte and catholyte are often referred to as the negative electrolyte and positive electrolyte, respectively, and these terms can be used interchangeably. As used herein, the terms anolyte and catholyte refer to electrolytes composed of electrochemically active components and an aqueous supporting solution.

### II. Introduction

Ion exchange membranes are broadly used in fuel cells, electrolyzers, flow batteries, and other technologies. These ion exchange membranes are among the most expensive elements of such devices and technologies because they frequently rely on high-cost polymers, such as Nafion®. Ion exchange membranes can become worn, damaged, or exhausted during their use, and may require replacement, recycling, or replenishment.

Over the course of a device's lifecycle, the performance of the ion exchange membrane materials will decrease because the membranes can develop physical or chemical defects during use. For example, an ion exchange membrane can develop holes, voids, or tears during use, or can become chemically contaminated, or attacked by oxygen radicals. Such defects and/or contamination can degrade the membrane performance. However, because replacing degraded membranes with new membrane materials is expensive, there is a need in the art for improved efficient and cost-effective methods to recover or refurbish existing membrane materials after their use.

In addition to the high cost associated with ion exchange membrane materials, disposal of used or damaged ion exchange membrane materials also poses a challenge. In particular, many ion exchange membrane materials have a chemically stable polytetrafluoroethylene (PTFE) backbone, which will be slow to biodegrade. It is therefore desirable to recycle ion exchange membrane materials, both to save on cost and to reduce challenges associated with the disposal of these materials.

Methods of recycling ion exchange membranes generally require removing the ion exchange membrane from the parent device, replacing lost or exhausted catalyst materials, and recasting the ion exchange membrane. In conventional methods, ion exchange membranes are typically recycled by using alcohol, water, or an alcohol/water mixture treatment to dissolve the ion exchange membrane. However, because ion exchange membranes are typically made of large molecules, such as Nafion®, and these large molecules do not dissolve easily, these methods require high temperatures (for example, greater than 150° C.) and in some cases also require high pressure to facilitate recycling.

The need to employ high dissolution temperature or pressure increases the cost of recycling the membrane. Furthermore, these high temperatures and pressures, risk damage to other components of fuel cell devices, such as catalyst materials (e.g., platinum and/or iridium catalysts); therefore, avoiding these parameters is desirable. While efforts to reduce the dissolution temperature of membranes using the solvents dimethylformamide (DMF) and dimethyl sulfoxide (DMSO), such methods have not been shown to be viable at temperatures below 100° C. It is desirable, however, for the dissolution temperature to be reduced further. Additionally, some solvents which are capable of dissolving the membrane materials have comparatively low flash points, which can pose risks during the dissolution process, such as a risk of fire or explosion.

Accordingly, there exists a need for improved methods for recycling and repurposing used or failed membranes and membrane materials. Particularly, it is desirable to develop methods for recycling ion exchange membranes that lower the temperature or pressure of the dissolution step to reduce the cost of recycling the membrane. In the methods disclosed herein, this is accomplished by exposing the membrane materials to aprotic solvents, which are capable of dissolving the membrane materials at temperatures below and sometimes greatly below 100° C. Following the dissolution of the membrane materials, recycled and/or regenerated ionically conductive membranes can be manufactured, and incorporated in one or more of the devices disclosed herein.

### III. Method

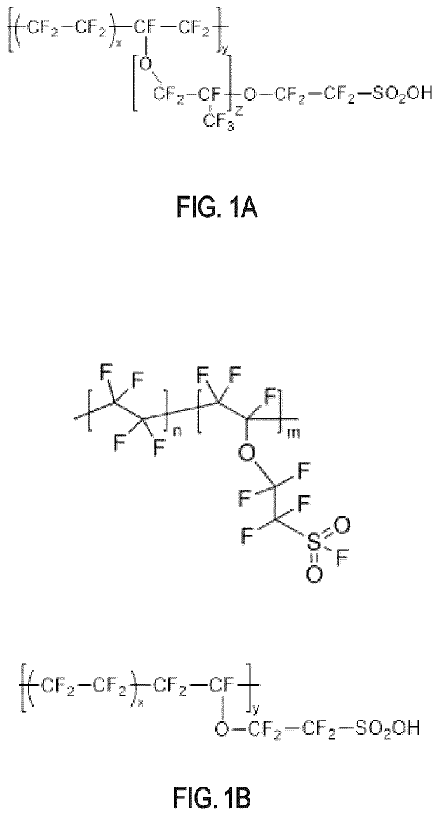

Aspects of the present disclosure concern a method for recycling ion exchange membranes, particularly ion exchange membranes capable of transporting protons (in some aspects of the disclosure, referred to as cation exchange membranes and/or proton exchange membranes, or “PEMs”), such as polyfluorinated polymer membranes. Exemplary polyfluorinated polymer membranes can include those sold under the trade names Nafion® and Aquivion®, which can be purchased from MilliporeSigma. Exemplary chemical structures for Nafion® and Aquivion® are provided in FIGS. 1A and 1B, respectively.

For the exemplary chemical structure of FIG. 1A, in some aspects, values of x, y, and z can be selected from integers that provide an equivalent weight ranging from 100 g/mol to 2000 g/mol. In some aspects, values of x, y, and z can be selected from integers that provide an equivalent weight ranging from 500 g/mol to 1500 g/mol. In some aspects, values of x, y, and z can be selected from integers that provide an equivalent weight ranging from 900 g/mol to 1100 g/mol. In some aspects, x ranges from 1 to 20. In some aspects, x ranges from 3 to 18. In some aspects, x ranges from 5 to 15. In some aspects, y ranges from 1 to 20. In some aspects, y ranges from 1 to 10. In some aspects, y ranges from 1 to 5. In some aspects, z ranges from 1 to 10. In some aspects, z ranges from 1 to 5. In some aspects, z ranges from 1 to 3.

FIG. 1B shows exemplary chemical structures for Aquivion® in a sulfonic acid form (—SO₃H) and in sulfonyl fluoride form (—SO₂F). For the sulfonyl fluoride form, in some aspects, values of m and n can be selected from integers that provide an equivalent weight ranging from 100 g/mol to 2000 g/mol. In some aspects, values of m and n can be selected from integers that provide an equivalent weight ranging from 100 g/mol to 1500 g/mol. In some aspects, values of m and n can be selected from integers that provide an equivalent weight ranging from 700-1200 g/mol. In some aspects, m ranges from 1 to 20. In some aspects, m ranges from 3 to 18. In some aspects, m ranges from 5 to 15. In some aspects, n ranges from 1 to 200. In some aspects, n ranges from 1 to 100. In some aspects, n ranges from 50 to 100.

For the sulfonic acid form, in some aspects, values of x, y, and z can be selected from integers that provide an equivalent weight ranging from 100 g/mol to 2000 g/mol. In some aspects, values of x, y, and z can be selected from integers that provide an equivalent weight ranging from 100 g/mol to 1500 g/mol. In some aspects, values of x, y, and z can be selected from integers that provide an equivalent weight ranging from 700-1200 g/mol. In some aspects, x ranges from 1 to 200. In some aspects, x ranges from 1 to 100. In some aspects, x ranges from 50 to 100. In some aspects, y ranges from 1 to 20. In some aspects, y ranges from 3 to 18. In some aspects, y ranges from 5 to 15.

Nafion® and Aquivion® are chemically stable polyfluorocarbon polymers, with sulfonic acid and/or sulfone groups attached to side chains of a fluorocarbon backbone (such as PTFE). Nafion® is a long side chain perfluorinated sulfonic acid polymer, with a fluoroether side chain connecting a sulfonic acid group to the PTFE backbone. Aquivion® is a short side chain perfluorinated sulfonic acid polymer, with a fluoroether side chain connecting a sulfonic acid group or a fluoro-sulfone group to the PTFE backbone. It is to be appreciated that, in some aspects of the disclosure, the methods disclosed herein may be used to dissolve other perfluorinated sulfonic acid polymers and/or other types of membranes used in the art, and further that the use of the disclosed method to dissolve Nafion® and/or Aquivion® is only an illustrative example of the method.

In aspects of the disclosure concerning using the method to dissolve fluorinated polymer ion exchange membranes, the sulfonic acid groups facilitate cation (e.g., proton) transfer through the fluorocarbon chain matrix. Meanwhile, the polyfluorocarbon chain matrix prevents the transfer of electrons across directly across the membrane, and prevents reactant gases (for example, H₂ and O₂) from passing through the membrane. In aspects of devices disclosed herein, the ionic conductivity and electrical resistance of the PEM material are important characteristics to the function of the device incorporating the PEM. Additionally, because the positive electrode and/or the negative electrode may be porous, it is also useful if the membrane is impermeable to the reactant gases and/or liquids and therefore able to prevent reactant gases and/or liquids from crossing through the electrode.

Over time, however, the membrane material can develop physical defects, such as holes or voids, which can reduce the ionic conductivity and/or the electrical resistance of the material, and which may provide a pathway for the reactant gases and/or liquids to pass across the membrane. Each of these issues can reduce the efficiency of the device incorporating the membrane. Furthermore, because these devices typically operate at elevated temperatures (e.g., temperatures of 80° C. or higher) in order to facilitate the chemical reactions and ionic conductivity of the membrane, the membrane itself may experience physical creep deformation (that is, the gradual deformation over time under persistent mechanical stresses) because exposure to the elevated temperature can depress the yield point of the membrane material. As the membrane material undergoes creep deformation, conformity between the membrane and the positive electrode and/or the negative electrode can decline over the lifetime of the device, which can impede cation (e.g., proton) transfer across the membrane by reducing contact area between the membrane and the positive electrode and/or the negative electrode.

Moreover, when the PEM material becomes chemically contaminated, for example, by oxygen radicals or metallic ions, the ability of the membrane to transport ions between the positive electrode and the negative electrode can become degraded. In the case of oxygen radicals, protons may chemically bond to a free electron of the radical, rather than passing across the membrane to complete the reaction. In the case of metallic ion contamination, the metallic ions can impair cation (e.g., proton) conduction through the membrane by binding to the sulfonic acid and/or sulfone groups. This may be particularly problematic for devices disclosed herein, which can incorporate metals, such as platinum, as a catalyst, which in turn may be introduced to the membrane by the corrosion of the electrodes.

Because the performance of the PEM membrane can be expected to degrade over the lifecycle of the device and because the membrane materials (e.g., Nafion® and Aquivion®) are expensive, it is desirable to regenerate or recycle the membrane material versus simply replacing it. The present disclosure concerns a new, low-temperature method for recycling such materials. In some aspects of the disclosure, the method comprises dissolving the membrane to allow the membrane polymer to be separated from contaminants, such as oxygen radicals and/or metal ions, and subsequently recasting the resulting polymer solution to form a new membrane, free of physical defects (e.g., holes or pores), as well as free from the effects of creep deformation, and having a reduced concentration of contaminants.

In some aspects of the disclosure, the method comprises exposing a PEM to a solvent, such as the aprotic organic solvents described in greater detail herein. Exposure to the solvent can cause the PEM to swell and become detached from the other components of the device, such as the positive electrode and the negative electrode of the fuel cell, the flow battery, the electrolyzer, and/or the catalyst components of such devices. Continued exposure to the solvent at temperatures of 40° C. or higher. For example, exposing the membrane to the solvent for prolonged periods at temperatures ranging from 40° C. to 80° C., such as 45° C. to 80° C., 50° C. to 80° C., 55° C. to 80° C., 60° C. to 80° C., 65° C. to 80° C., 70° C. to 80° C., or 75° C. to 80° C., can cause complete dissolution of the PEM into a solution comprising the particles of the membrane polymer dispersed in the solvent. In some aspects of the disclosure, the dissolution temperature may be further reduced by increasing the pressure under which the dissolution occurs. In some aspects of the disclosure, the polymer of the PEM can be dispersed in a protic or an aprotic solvent. In representative aspects of the disclosure, the solvent is an aprotic solvent discussed in further detail herein.

In some aspects of the disclosure, aprotic solvents are preferred, because these are polar solvents that do not donate a cation (e.g., proton) to the solution. Without being bound to any particular theory, it is currently believed that polar, aprotic solvents are useful for dissolving the PEM materials disclosed herein due to the interaction between the solvent and the perfluorosulfonic acid polymer, and more particularly the polar sulfonic acid-terminated side chain of the perfluorosulfonic acid polymer. Suitable polar, aprotic solvents for the PEM recycling methods disclosed herein can include (but are not limited to) phosphates, phosphonates, phosphites, sulfoxides, amides, or any combination thereof.

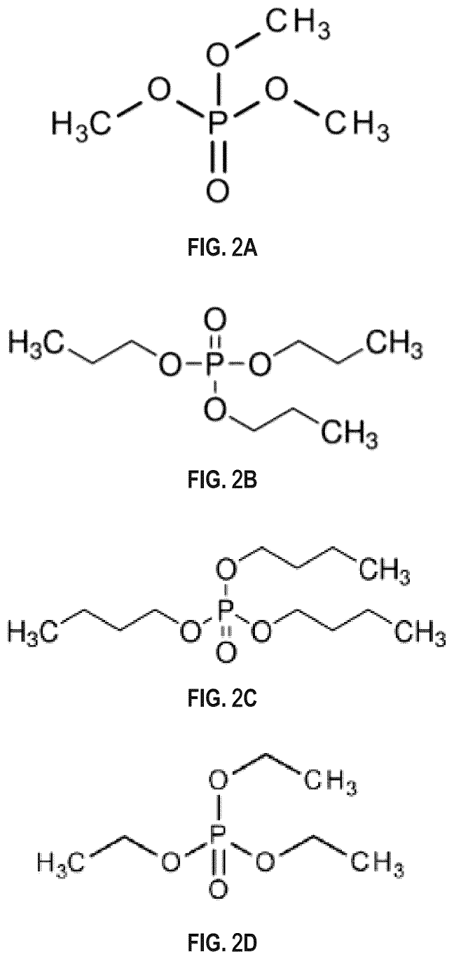

Phosphate solvents that may be suitable for the PEM recycling methods disclosed herein can include, for example, trimethyl phosphate, tripropyl phosphate, tributyl phosphate, triethyl phosphate, or any combination thereof. Structures of these solvents are shown in FIGS. 2A-2D, respectively. Such solvents may advantageously be nonflammable and/or resistant to combustion.

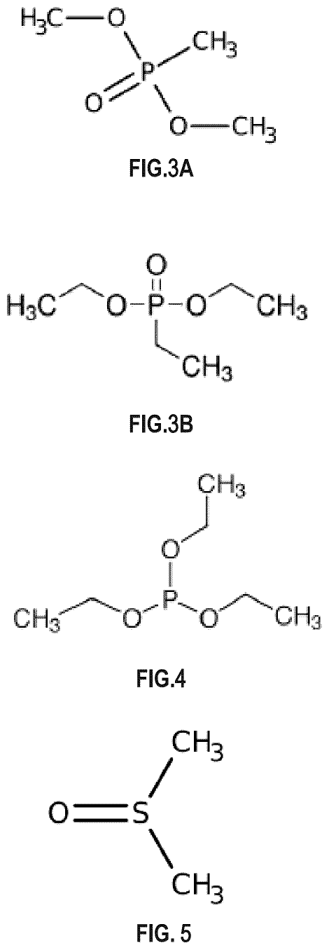

Phosphonate solvents that may be suitable for the PEM recycling methods disclosed herein can include, for example, dimethyl methylphosphonate and/or diethyl ethylphosphonate, the structures of which are shown in FIGS. 3A-3B, respectively. Such solvents may advantageously be nonflammable and/or may be resistant to combustion.

Phosphite solvents that may be suitable for the PEM recycling methods disclosed herein can include, for example, triethyl phosphite, as shown in FIG. 4.

Sulfoxide solvents that may be suitable for the PEM recycling methods disclosed herein can include, for example, dimethyl sulfoxide, as shown in FIG. 5. Such solvents may advantageously be nonflammable and/or resistant to combustion.

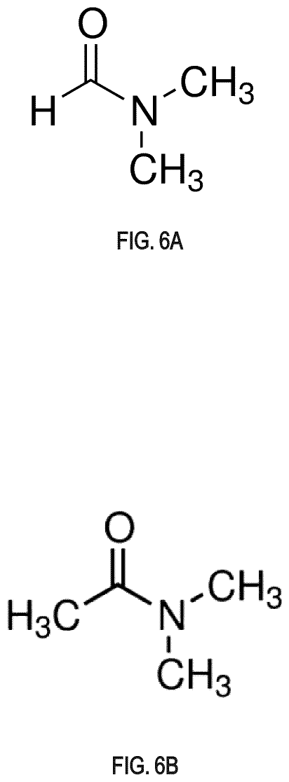

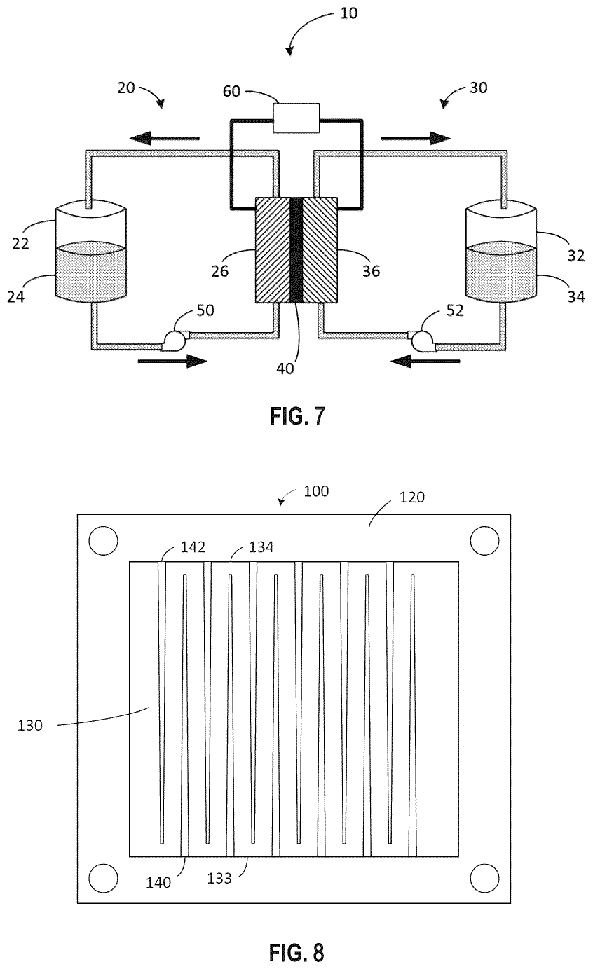

Amide solvents that may be suitable for the PEM recycling methods disclosed herein can include, for example, N,N-dimethylformamide and/or dimethylacetamide, as shown in FIGS. 6A-6B, respectively.

Advantageously, solvents disclosed herein for use in the disclosed method can have flashpoints ranging from 60° C. to 150° C., including above 65° C., such as 70° C. to 150° C., 75° C. to 150° C., 80° C. to 150° C., 85° C. to 150° C., 90° C. to 150° C., 95° C. to 150° C., or 100° C. to 150° C. The use of high flash point solvents, such as solvents having a flash point above 65° C., is advantageous because doing so reduces the risk that the solvent may combust during the dissolution of the membrane material. The exemplary phosphite, phosphonate, and/or amide solvents may, for example, have a flashpoint of 65° C. or greater. The exemplary sulfoxide solvents may have a flashpoint of 85° C. or greater. The exemplary phosphate solvents may have flashpoints of 100° C. or greater. More particularly, diethyl ethylphosphonate has a flashpoint of above 90° C., trimethyl phosphate has a flashpoint of above 105° C., and tributyl phosphate has a flashpoint of above 145° C. It will be appreciated that the use of solvents with elevated flashpoints will offer several safety advantages to the methods disclosed herein.

In some aspects of the disclosure, the PEM dissolution may occur at temperatures of 80° C. or lower, such as between ambient temperature and 80° C. In particular aspects of the disclosure, the PEM dissolution can occur at temperatures between 30° C. and 80° C., such as at 40° C. to 80° C., or 40° C. to 70° C., or 40° C. to 60° C., including 30° C., 40° C., 50° C., 60° C., or 70° C. While dissolution at low temperatures is generally desirable to lower the energy cost of the recycling methods disclosed herein, reaction kinetics increase with increasing temperature, and therefore conventional dissolution methods often are not effective at low temperatures (for example, at temperatures below 80° C.). However, when the PEM materials disclosed herein are exposed to one or more of the solvents disclosed herein, dissolution can occur at lower temperatures than are typically observed with the use of conventional methods. The solvents disclosed herein facilitate decreasing the temperatures used for recycling methods disclosed herein, allowing the perfluorosulfonic acid polymer to be regenerated at lower cost. Moreover, by reducing the reaction temperature below the flashpoint of the solvent used, the safety of the process can be improved by reducing the or eliminating the likelihood of solvent combustion and/or explosion.

In some aspects of the disclosure, the swelling and/or dissolution of the membrane polymer material can be accomplished at even lower temperatures by increasing the pressure under which the polymer materials are exposed to one or more of the solvents disclosed herein. It is to be understood, however, that elevated pressure is an optional aspect of the disclosed method, and that the dissolution may be accomplished at the temperatures disclosed herein without having to modify the pressure, particularly when the temperatures and solvents disclosed herein are used.

The aprotic solvents disclosed herein can form a solution that separates the perfluorosulfonic acid polymer from contaminants, such as oxygen radicals and/or metal ions, because these contaminants are not suspended and/or dispersed within the aprotic solvent along with the perfluorosulfonic acid polymer. The polymer solution yielded by the dissolution of the PEM can be recast by gelling and in some cases curing the dispersion of polymer (for example, those sold as Nafion® of Aquivion®), as described herein, to yield a recycled membrane with a lower concentration of contaminants and/or defects.

Because contaminants such as oxygen radicals and/or metal ions are not carried with the polymer particles into solution, the regenerated membrane may have a reduced concentration of these contaminants. Moreover, because the membrane can be recast with a desired shape or form factor, it will also be regenerated without physical defects, or at least with a reduced quantity of physical defects relative to the spent membrane. Physical defects that can be avoided and/or reduced can include holes, pores, or creep deformation. Therefore, the recycling process disclosed herein enables the formation of a new PEM with properties (such as ionic conductivity and electrical resistance) that are improved over the properties of the membrane before recycling.

The recycled membranes can thereafter be incorporated into any of the devices disclosed herein, or any other device which may employ a cation (e.g., proton) exchange membrane. In this way, the method disclosed herein can be used to regenerate membranes for use in recycle fuel cells, flow batteries, electrolyzers, and other devices that utilize membranes, such as perfluorosulfonic acid polymer membranes. Thus, the cost of replacing or repairing devices which include such membranes that have experienced a degradation of properties, such as electrical resistance or ionic conductivity, can be reduced, by avoiding the need to use new polymer material to replace the degraded membrane material.

While the methods disclosed herein are principally discussed with reference to cation (e.g., proton) exchange membranes, such as those sold as Nafion® and Aquivion®, it is to be appreciated that these methods are likewise applicable to ion exchange membranes that conduct other ions, such as ion exchange membranes that conduct anions.

### IV. Ion Exchange Devices

The recycled ion exchange membranes provided by the methods disclosed herein can be incorporated into various devices, including fuel cells, flow batteries, and electrolyzers. Flow batteries, such as redox flow batteries (RFBs) can provide electrical energy converted from chemical energy continuously, and are promising systems for energy storage, providing flexibility and resiliency to the power grid. Fuel cells are an important part of a hydrogen-based power system, allowing hydrogen fuels to be converted into electrical power with low or minimal emissions. Electrolyzers are also important to a hydrogen-based power system, by converting water into hydrogen, thus allowing electrical energy to be converted into chemical potential.

Each of these technologies relies on a positive electrode and a negative electrode separated by a material that is permeable to ions (for example, hydrogen ions), but impermeable to electrons. Ion exchange membranes are ideally suited to this application because they are both electrically resistive and ion conductive and can also form a water and/or moisture tight barrier between the positive electrode and the negative electrode.

In one exemplary redox flow battery, shown in FIG. 7, an aqueous RFB (ARFB) system 10 comprises a positive half cell 20 and a negative half cell 30. The half cells are separated by the recycled membrane 40, such as a recycled ion exchange membrane obtained using the method disclosed herein, which may be permeable to particular ion species and impermeable to other ion species and to electrons. The positive half cell 20 comprises an electrode tank 22 containing a catholyte 24 and the negative half cell 30 comprises an electrode tank 32 containing an anolyte 34. The positive half-cell 20 further comprises a positive electrode (e.g., cathode) 26, and the negative half-cell 30 further comprises a negative electrode (e.g., anode) 36. The anolyte and catholyte are solutions comprising electrochemically active components in different oxidation states. The electrochemically active components in the catholyte and anolyte couple as redox pairs. In some aspects of the disclosure, at least one of the catholyte and anolyte redox active materials remains fully soluble during the charging and discharging cycles of the RFB.

The battery may be assembled in ambient atmosphere in a housing that is closed and operated without flowing an inert gas through the housing. In some aspects of the disclosure, the housing may be sealed such that additional oxygen from the ambient atmosphere is excluded or substantially excluded. Embodiments of the disclosed battery may operate at a lower cost than comparable RFBs that require constant flow of an inert gas.

During charging and discharging of the ARFB, the catholyte and anolyte are continuously circulating via pumps 50, 52 through the positive and negative electrodes 26, 36, respectively, where redox reactions proceed, providing the conversion between chemical energy and electrical energy or vice versa. To complete the circuit during use, positive and negative electrodes 26, 36 (including a current collector at each side in some aspects) of the ARFB system 10 are electrically connected through current collectors (not shown) with an external load 60. The electrodes are selected to be stable with the anolyte and catholyte. In some aspects of the disclosure, the electrodes are carbon-based. Suitable carbon-based materials include, but are not limited to, carbon felt, carbon paper, woven carbon cloth, or any combination thereof. Exemplary recycled membranes include, but are not limited to, cation exchange membranes that have been obtained using the method disclosed herein, such as recycled Nafion®, N115, NR 212, and NR 211 membranes (available from Ion Power, Inc., New Castle, DE).

In some aspects of the disclosure, the ARFB is a flow cell with an interdigitated design of flow channels. FIG. 8 is a simplified diagram of one exemplary half cell 100 comprising a support frame 120 and a bipolar plate 130 with interdigitated inlet and outlet flow channels 140, 142. The inlet flow channels 140 extend inwardly from a first side edge 133 of the bipolar plate 130 and have a closed distal end. The outlet flow channels 142 extend inwardly from the opposing side edge 134 of the bipolar plate and also have a closed distal end. The bipolar plate 130 may also include flow channels on the opposing surface with anolyte circulating through the channels on one side of the plate and catholyte circulating through the flow channels on the opposing side.

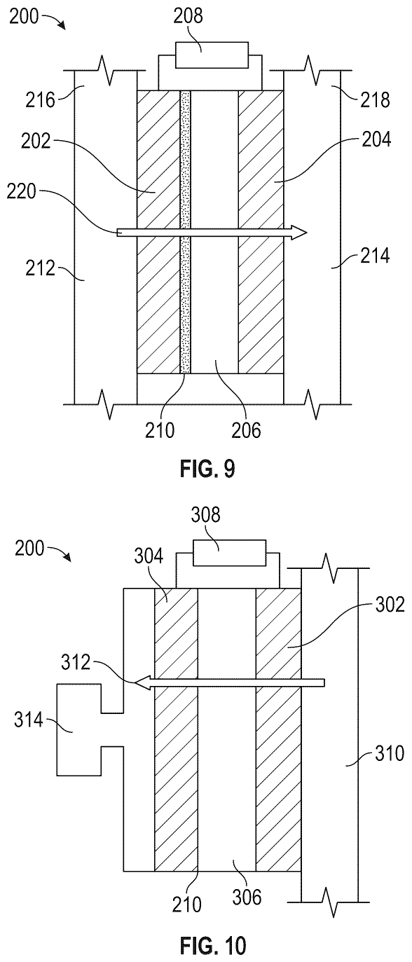

An exemplary fuel cell 200 incorporating a recycled ion exchange membrane is illustrated in FIG. 9. As shown in FIG. 9, the fuel cell 200 comprises an anode 202, a cathode 204, and a recycled ion exchange membrane 206 separating the anode 202 and the cathode 204. The anode 202 and the cathode 204 can be electrically connected through current collectors (not shown) with an external load 208. In some aspects of the disclosure, the anode 202 and the cathode 204 can be gas-permeable to facilitate the use of gaseous fuels, such as hydrogen. The fuel cell 200 can also include a catalyst 210, which may in some aspects of the disclosure, be in contact with the anode 202 to facilitate splitting the fuels, such as hydrogen, into ions and free electrons.

The fuel cell 200 also includes a fuel flow channel 212, which is in fluid communication with the anode 202, and an air flow channel 214, which is in fluid communication with the cathode 204. In operation, a flow of fuel, such as hydrogen, is introduced to the anode 202 through a fuel inlet 216 of the fuel flow channel 212, while a flow of air is introduced to the cathode 204 through an air inlet 218 of the air flow channel 214. In example fuel cells using a hydrogen fuel, hydrogen is split into ions and free electrons at the anode, with the aid of the catalyst 210. Because the recycled ion exchange membrane is permeable to ions and impermeable to electrons, the ions (for example, ions provided by the hydrogen fuel) may cross membrane 206 directly from the anode 202 to the cathode 204, in the direction indicated by the arrow 220, to react with O₂ from the air inlet 218, while the free electrons must cross from the anode to the cathode through the current collectors (and therefore across the external load 208), to complete the generalized fuel cell reaction of

$$2 {H}^{+} + \frac{1}{2} {O}_{2} + 2 {e}^{-} \to {H}_{2} O .$$

Thus, the fuel cell can be used to convert the chemical energy of a fuel such as hydrogen into electrical energy.

An exemplary electrolyzer 300, which incorporates a recycled ion exchange membrane, is shown in FIG. 10. The electrolyzer 300 comprises an anode 302, a cathode 304, and a recycled ion exchange membrane 306 separating the anode 302 and the cathode 304. A hydrogen source, such as water, is introduced to the electrolyzer at an inlet channel 310 adjacent to the anode 302. The hydrogen source can be decomposed at the anode 302 into hydrogen and a byproduct. For example, in aspects of the disclosure where the hydrogen source is water, the hydrogen source will be split into oxygen, hydrogen ions, and free electrons according to the following equation:

$${H}_{2} {O}^{+} \to {O}_{2} + 4 {H}^{+} + 4 {e}^{-} .$$

This reaction is endothermic, and is typically driven by a voltage source, such as the voltage source 308 electrically connected to the anode 302 and the cathode 304, which supplies at least a portion of the necessary energy to split the water according to the reaction described above.

The oxygen may thereafter be discharged from the electrolyzer 300 as a waste gas or collected. Because the recycled membrane 306 is permeable to the hydrogen ions, and impermeable to the free electrons, and because the voltage source draws the free electrons from the anode 302 to the cathode 304, the positively-charged hydrogen ions can transit across the recycled membrane 306 to the cathode 304, in the direction indicated by arrow 312 to form hydrogen according to the following reaction, with the hydrogen collected, for example, in a reservoir 314:

$$4 {H}^{+} + 4 {e}^{-} \to 2 {H}_{2} .$$

In each of the disclosed devices, the use of an ion exchange membrane recycled according to the methods disclosed herein can provide a device assembled at lower cost. Additionally, the use of an ion exchange membrane recycled according to the methods disclosed herein can allow for a device that has lost performance due to deterioration of the membrane component to be restored.

### V. Overview of Several Embodiments

In view of the above-described implementations of the disclosed subject matter, this application discloses the additional examples enumerated below. It should be noted that one feature of an example in isolation or more than one feature of the example taken in combination and, optionally, in combination with one or more features of one or more further examples are further examples also falling within the disclosure of this application.

Disclosed herein are aspects of a method for recycling an ion exchange membrane, comprising: exposing a first ion exchange membrane comprising a polymer to a solvent at a temperature of no greater than 80° C.; dissolving the first ion exchange membrane to form a polymer dispersion; and recasting the polymer dispersion to form a recycled ion exchange membrane.

In any or all of the above aspects, the recycled ion exchange membrane comprises a lower concentration of voids, tears, and/or pores as compared to the first ion exchange membrane.

In any or all of the above aspects, the recycled ion exchange membrane comprises a lower concentration of oxygen radicals or a lower concentration of metal ions than the first ion exchange membrane.

In any or all of the above aspects, the first ion exchange membrane is a cation exchange membrane.

In any or all of the above aspects, the polymer is a perfluorosulfonic acid polymer.

In any or all of the above aspects, the perfluorosulfonic acid polymer comprises a polyfluorocarbon backbone; a sulfonic acid group or a fluoro-sulfone group; and a side chain connecting the sulfonic acid group or the fluoro-sulfone group to the polyfluorocarbon backbone.

In any or all of the above aspects, the solvent has a flashpoint of 65° C. or greater.

In any or all of the above aspects, the solvent comprises a phosphate, a phosphonate, a phosphite, a sulfoxide, an amide, or any combination thereof.

In any or all of the above aspects, the solvent is selected from trimethyl phosphate, tripropyl phosphate, tributyl phosphate, triethyl phosphate, dimethyl methylphosphonate, diethyl ethylphosphonate, triethyl phosphite, dimethyl sulfoxide, N,N-dimethylformamide, or a combination thereof.

In any or all of the above aspects, the solvent is triethyl phosphate.

In any or all of the above aspects, the temperature ranges from 40° C. to 70° C.

In any or all of the above aspects, the temperature is less than or equal to 50° C.

In any or all of the above aspects, the method is conducted at normal pressure.

In any or all of the above aspects, the method is conducted under reduced pressure.

In any or all of the above aspects, the first ion exchange membrane comprises a perfluorosulfonic acid polymer, the solvent is triethyl phosphate, and the temperature is less than or equal to 50° C.

Also disclosed herein are aspects of a method, comprising: exposing a first ion exchange membrane comprising a perfluorosulfonic acid polymer to a polar, aprotic solvent at a temperature ranging from 30° C. to 60° C.; dissolving the first ion exchange membrane to form a perfluorosulfonic acid polymer dispersion; and recasting the perfluorosulfonic acid polymer dispersion to form a recycled ion exchange membrane exhibiting reduced defects as compared to the first ion exchange membrane.

Also disclosed herein are aspects of a device including an ion exchange membrane recycled according to the method of any example herein, particularly examples 1-16.

In any or all of the above aspects, the device is a fuel cell, an electrolyzer, or a flow battery.

Also disclosed herein are aspects of a device, comprising: a positive electrode, a negative electrode, and a recycled polymer membrane disposed between the positive electrode and the negative electrode, wherein the recycled polymer membrane is obtained from the method of any example herein, particularly examples 1-16; and an electrical load in electrical communication with the positive electrode and the negative electrode.

Also disclosed herein are aspects of a method for recycling an ion exchange membrane, comprising: exposing a first ion exchange membrane comprising a polymer to a solvent at a temperature of no greater than 80° C.; dissolving the first ion exchange membrane to form a polymer dispersion; and recasting the polymer dispersion to form a recycled ion exchange membrane.

In any or all of the above aspects, the recycled ion exchange membrane comprises a lower concentration of voids, tears, pores, or any combination thereof, as compared to the first ion exchange membrane.

In any or all of the above aspects, the recycled ion exchange membrane comprises a lower concentration of oxygen radicals or a lower concentration of metal ions than the first ion exchange membrane.

In any or all of the above aspects, the first ion exchange membrane is a cation exchange membrane.

In any or all of the above aspects, the polymer is a perfluorosulfonic acid polymer.

In any or all of the above aspects, the perfluorosulfonic acid polymer comprises a polyfluorocarbon backbone; a sulfonic acid group or a fluoro-sulfone group; and a side chain connecting the sulfonic acid group or the fluoro-sulfone group to the polyfluorocarbon backbone.

In any or all of the above aspects, the perfluorosulfonic acid polymer has a structure according to Chemical Formula I, Chemical Formula II, or Chemical Formula III, or wherein the perfluorosulfonic acid polymer comprises a mixture of two or more compounds having structures according to Chemical Formula I, Chemical Formula II, or Chemical Formula III,

wherein Chemical Formula I is

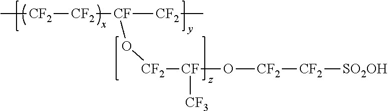

wherein values of x, y, and z are selected from integers that provide an equivalent weight for the perfluorosulfonic acid polymer ranging from 100 g/mol to 2000 g/mol;

### Chemical Formula II is

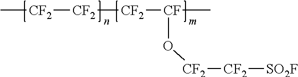

wherein values of m and n are selected from integers that provide an equivalent weight for the perfluorosulfonic acid polymer ranging from 100 g/mol to 2000 g/mol; and

### Chemical Formula III is

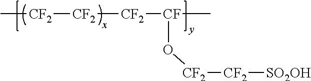

wherein values of x, y, and z are selected from integers that provide an equivalent weight for the perfluorosulfonic acid polymer ranging from 100 g/mol to 2000 g/mol.

In any or all of the above aspects, the solvent has a flashpoint of 65° C. or greater.

In any or all of the above aspects, the solvent comprises a phosphate, a phosphonate, a phosphite, a sulfoxide, an amide, or any combination thereof.

In any or all of the above aspects, the solvent comprises trimethyl phosphate, tripropyl phosphate, tributyl phosphate, triethyl phosphate, dimethyl methylphosphonate, diethyl ethylphosphonate, triethyl phosphite, dimethyl sulfoxide, N,N-dimethylformamide, or any combination thereof.

In any or all of the above aspects, the solvent is triethyl phosphate.

In any or all of the above aspects, the temperature ranges from 40° C. to 70° C.

In any or all of the above aspects, the temperature is less than or equal to 50° C.

In any or all of the above aspects, the method is conducted at ambient pressure.

In any or all of the above aspects, the first ion exchange membrane comprises a perfluorosulfonic acid polymer, the solvent is triethyl phosphate, and the temperature is less than or equal to 50° C.

Also disclosed herein are aspects of a method, comprising: exposing a first ion exchange membrane comprising a perfluorosulfonic acid polymer to a polar, aprotic solvent at a temperature ranging from 30° C. to 60° C.; dissolving the first ion exchange membrane to form a perfluorosulfonic acid polymer dispersion; and recasting the perfluorosulfonic acid polymer dispersion to form a recycled ion exchange membrane exhibiting reduced defects as compared to the first ion exchange membrane.

In any or all of the above aspects, the method is conducted at ambient pressure.

In any or all of the above aspects, the temperature ranges from 30° C. to 50° C.

Also disclosed herein are aspects of a device, comprising: a positive electrode; a negative electrode; a recycled polymer membrane disposed between the positive electrode and the negative electrode, wherein the recycled polymer membrane is obtained by exposing a first ion exchange membrane comprising a polymer to a solvent at a temperature of no greater than 80° C., dissolving the first ion exchange membrane to form a polymer dispersion, and recasting the polymer dispersion to form the recycled ion exchange membrane; and an electrical load in electrical communication with the positive electrode and the negative electrode.

In any or all of the above aspects, the device is a fuel cell, an electrolyzer, or a flow battery.

### VI. Examples

In one particular example, a membrane comprising Nafion® polymer was exposed to a triethyl phosphate solvent at temperatures below 80° C., and at ambient pressure. In this example, the temperature of the process was increased until dissolution of the membrane was observed. Initial breakdown of the membrane (swelling and separation from the electrodes and/or the catalyst) was observed at a temperature of 40° C., with full dissolution of the membrane into a polymer dispersion in the solvent occurring at a temperature of about 50° C.

In solution, the polymer material can comprise particles with a rod-like or cylindrical geometry (that is, the polymer particles in the dispersion can have an elongated geometry). To cause the formation of a regenerated or recycled polymer membrane, the solution can be at least partially evaporated. As the solution is evaporated, the quantity of solvent is reduced, while the amount of the perfluorosulfonic acid polymer in the solution is kept constant, causing a corresponding increase in concentration of the perfluorosulfonic acid polymer in the solution. As the concentration of the perfluorosulfonic acid polymer in the solution increases, it will reach the critical gelation concentration, a concentration of the perfluorosulfonic acid polymer in the solution at which the polymer particles (that is, the rods and/or cylinders) begin to form an interconnected network. Such a method can be used to provide the recycled ion exchange membrane.

Without being bound to any particular theory, it is currently believed that, if the solution is further evaporated to further reduce the quantity of solvent present in the solution (and corresponding further increase of the concentration of the perfluorosulfonic acid polymer), the polymer chains, and particularly the polytetrafluoroethylene backbone of the polymer, will increasingly entangle, which results in the formation of a regenerated membrane.

In view of the many possible ways in which the principles of the disclosure may be applied, it should be recognized that the illustrated configurations depict examples of the disclosed technology and should not be taken as limiting the scope of the disclosure nor the claims. Rather, the scope of the claimed subject matter is defined by the following claims and their equivalents.

We claim:

1. A method for recycling an ion exchange membrane, comprising:
exposing a first ion exchange membrane comprising a polymer to a solvent at a temperature of no greater than 80° C.;
dissolving the first ion exchange membrane to form a polymer dispersion; and
recasting the polymer dispersion to form a recycled ion exchange membrane.

2. The method of claim 1, wherein the recycled ion exchange membrane comprises a lower concentration of voids, tears, pores, or any combination thereof, as compared to the first ion exchange membrane.

3. The method of claim 1, wherein the recycled ion exchange membrane comprises a lower concentration of oxygen radicals or a lower concentration of metal ions than the first ion exchange membrane.

4. The method of claim 1, wherein the first ion exchange membrane is a cation exchange membrane.

5. The method of claim 1, wherein the polymer is a perfluorosulfonic acid polymer.

6. The method of claim 5, wherein the perfluorosulfonic acid polymer comprises:
a polyfluorocarbon backbone;
a sulfonic acid group or a fluoro-sulfone group; and
a side chain connecting the sulfonic acid group or the fluoro-sulfone group to the polyfluorocarbon backbone.

7. The method of claim 5, wherein the perfluorosulfonic acid polymer has a structure according to Chemical Formula I, Chemical Formula II, or Chemical Formula III, or wherein the perfluorosulfonic acid polymer comprises a mixture of two or more compounds having structures according to Chemical Formula I, Chemical Formula II, or Chemical Formula III,
wherein Chemical Formula I is 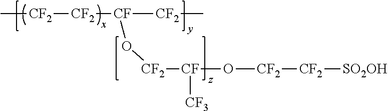
wherein values of x, y, and z are selected from integers that provide an equivalent weight for the perfluorosulfonic acid polymer ranging from 100 g/mol to 2000 g/mol;
Chemical Formula II is 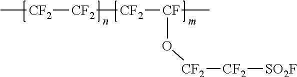
wherein values of m and n are selected from integers that provide an equivalent weight for the perfluorosulfonic acid polymer ranging from 100 g/mol to 2000 g/mol; and
Chemical Formula III is 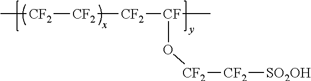
wherein values of x, y, and z are selected from integers that provide an equivalent weight for the perfluorosulfonic acid polymer ranging from 100 g/mol to 2000 g/mol.

8. The method of claim 1, wherein the solvent has a flashpoint of 65° C. or greater.

9. The method of claim 1, wherein the solvent comprises a phosphate, a phosphonate, a phosphite, a sulfoxide, an amide, or any combination thereof.

10. The method of claim 9, wherein the solvent comprises trimethyl phosphate, tripropyl phosphate, tributyl phosphate, triethyl phosphate, dimethyl methylphosphonate, diethyl ethylphosphonate, triethyl phosphite, dimethyl sulfoxide, N,N-dimethylformamide, or any combination thereof.

11. The method of claim 1, wherein the solvent is triethyl phosphate.

12. The method of claim 1, wherein the temperature ranges from 40° C. to 70° C.

13. The method of claim 1, wherein the temperature is less than or equal to 50° C.

14. The method of claim 1, wherein the method is conducted at ambient pressure.

15. The method of claim 1, wherein the first ion exchange membrane comprises a perfluorosulfonic acid polymer, the solvent is triethyl phosphate, and the temperature is less than or equal to 50° C.

16. A method, comprising:
exposing a first ion exchange membrane comprising a perfluorosulfonic acid polymer to a polar, aprotic solvent at a temperature ranging from 30° C. to 60° C.;
dissolving the first ion exchange membrane to form a perfluorosulfonic acid polymer dispersion; and
recasting the perfluorosulfonic acid polymer dispersion to form a recycled ion exchange membrane exhibiting reduced defects as compared to the first ion exchange membrane.

17. The method of claim 16, wherein the method is conducted at ambient pressure.

18. The method of claim 16, wherein the temperature ranges from 30° C. to 50° C.

19. A device, comprising:
a positive electrode;
a negative electrode;
a recycled polymer membrane disposed between the positive electrode and the negative electrode, wherein the recycled polymer membrane is obtained by exposing a first ion exchange membrane comprising a polymer to a solvent at a temperature of no greater than 80° C., dissolving the first ion exchange membrane to form a polymer dispersion, and recasting the polymer dispersion to form the recycled ion exchange membrane; and
an electrical load in electrical communication with the positive electrode and the negative electrode.

20. The device of claim 19, wherein the device is a fuel cell, an electrolyzer, or a flow battery.
